(19) United States
(12) Patent Application Publication
(10) Pub. No.: US 2026/0134387 A1
(43) Pub. Date: May 14, 2026

(54) SYSTEMS, DEVICES, AND METHODS FOR MULTIPORTAL ORCHESTRATION BETWEEN A PLURALITY OF ENTITIES

(71) Applicant: E-ventz, Inc., Arlington, VA (US)

(72) Inventors: WALID BEN HASSINE, Arlington, VA (US); Aroua Ben Nasr, Paris (FR); David Merritt, Alexandria, VA (US); Yasir Diab, Belmont, CA (US)

(73) Assignee: E-ventz, Inc., Arlington, VA (US)

(21) Appl. No.: 19/388,992

(22) Filed: Nov. 13, 2025

Related U.S. Application Data
(60) Provisional application No. 63/720,154, filed on Nov. 13, 2024.

(51) Int. Cl. G06Q 10/087; H04L 9/40

(52) U.S. Cl. CPC G06Q 10/0874; G06Q 10/0877; H04L 63/0435; H04L 63/0807; H04L 63/0861; H04L 2463/082

(57) ABSTRACT

A computer-implemented system for orchestrating event-related interactions between a plurality of portals, wherein the consumer portal comprises a plurality of consumers and is configured to receive consumer order data comprising a service request, an event time, or a budget constraint, a service provider portal, wherein the service provider portal comprises a plurality of service providers and is configured to receive service-provider availability data or service-parameter information, a merchant portal, wherein the merchant portal comprise a plurality of merchants and is configured to receive merchant availability data, merchant inventory data, menu data, or menu pricing information, an authentication module configured to perform multi-factor authentication comprising biometric verification and device verification to validate access to each of the consumer portal, the service-provider portal, and the merchant portal, and an orchestration engine.

### TECHNICAL FIELD

The present disclosure relates to event orchestration between various elements, entities, or players. In particular, the present disclosure relates to methods, systems, and devices for connecting and orchestrating between consumers, restaurants, catering companies, and other service entities seamlessly to allow consumers to order and cater pertinent orders in an efficient, cost-effective, and facile manner. Also, the present disclosure allows the various elements, entities, or players to anticipate demand and adjust services accordingly.

### BACKGROUND

Inventory and food management at restaurants is vital and crucial to maintaining profitability. Many times, restaurants find it difficult to establish proper inventory and food management due to an inability to anticipate and predict consumer demand. This results in restaurants ordering too much or too little perishable foods which leads to decreased profits, spoilage, and/or waste. Moreover, this also leads to an inferior consumer product and customer dissatisfaction, since many times certain menu items are frequently unavailable due to such poor inventory and food management. As such, there exists a need to predict and anticipate consumer demand to ensure proper inventory and food management.

Furthermore, the failure rates for restaurants are considered high. For example, the National Restaurant Association, a restaurant business association in the United States representing more than 380000 restaurant locations, estimates a 30% failure rate for restaurants. As a result, restaurants are consistently looking for ways to add income and revenue streams to prevent such failure.

Consumers, too, have a high demand for catering food from their favorite restaurants for private and personal events. Furthermore, service providers for such events, such as catering companies, florists, and other party-related and event-related services, also wish to connect to such consumers to add revenue streams and increase profitability.

Given this, there exists an overwhelming and vital need to connect and orchestrate between restaurants, consumers, and event service providers in a one-stop shop to allow each of said entities and players to connect, order from each other, and do commerce with one another. Moreover, there also exists a vital need for each of the said entities to predict and anticipate demand and adjust services accordingly.

### SUMMARY

Different from conventional solutions, the present disclosure solves the above problem(s) by providing methods, systems, and devices for connecting and orchestrating between consumers, restaurants, catering companies, and other service entities seamlessly to allow consumers to order and cater pertinent orders in an efficient, cost-effective, and facile manner. Also, the present disclosure allows the various elements, entities, or players to anticipate demand and adjust services accordingly. Indeed, such elements, entities, or players may be consumers, merchants, and/or service providers.

Ine one embodiment, the present disclosure’s event orchestration between consumers, restaurants, and catering companies allows consumers to view and order pertinent services and merchants and service providers to offer their services, effectively creating orchestration between all various entities and players, and providing a one-stop shop catering to all pertinent entities and players. The aforementioned event orchestration between consumers, restaurants, and catering companies further allows for the creation of a marketplace wherein services are provided and catered to, and orders are made by consumers

In a further embodiment, the present disclosure allows consumers to order restaurant services and/or food for an event or a personal event and to have such restaurant services and/or food catered by a catering company. The present disclosure further allows consumers to choose from a plethora of restaurants and/or mix and match menus, services, and/or food between a plethora of restaurants to cater for an event or a personal event. The present disclosure further allows consumers to choose from a plethora of service providers or event service providers such as catering companies to cater the restaurant-provided food in a professional manner, florists to provide appropriate floral arrangements at the pertinent venue, transportation providers such as party busses and limousines to provide appropriate transportation services, and/or wineries for private events, among other pertinent service providers.

In another embodiment, the present disclosure may comprise a system that connects and orchestrates between various elements, entities, or players. Further, the system may comprise three separate portals. One portal may be designated for restaurants, wherein restaurants may upload pertinent restaurant data such as address, physical location, availability, and/or detailed menus with pertinent information and costs, among other personal data. A second portal may be designated for event service provider companies such as catering companies, florists, and/or event transportation service providers. In this portal, an event service provider company may provide pertinent data such as the type of service provided, associated costs, and/or availability, among other personal data. A third portal may be designated for a consumer. In the third portal, the consumer may upload pertinent personal data and/or biometric data for authentication purposes, among other personal data. In this third portal, the consumer may search pertinent restaurant restaurants in the first portal for food and menus that meet his or her needs and budget requirements. Further, the consumer may connect the order from a selected restaurant in the first portal with a catering company selected from the second portal to allow for the catering of the selected restaurant’s food at the consumer’s private or personal event. In this way, the system allows consumers to connect with local catering companies so that consumers can receive food from their favorite restaurants to their homes and/or events when such restaurants do not offer moder in-home catering services. Alternatively or additionally, the catering company or any other event service provider in the second portal may see the incoming orders of the consumers on the first portal and bid for catering and/or other event services accordingly.

In a further embodiment, the system may allow for communication and orchestration between the various elements, entities, or players via the use of a network or a cloud. Alternatively or additionally, the system may allow for communication and orchestration between the various elements, entities, or players by allowing for communication between each of the various elements, entities, or players.

In still a further embodiment, the system may allow for the gathering of all data from each of the various elements, entities, or players. For example, the system may allow for the gathering of restaurant data such as address, physical location, availability, and/or detailed menus with pertinent information and costs, among other personal data from the restaurant, the gathering of event service provider data such as the type of service provided, associated costs, and/or availability, among other personal data, and the gathering of consumer data such as pertinent personal data and/or biometric data for authentication purposes, among other personal data. Thereafter, the system may utilize such data to build a large data training set that may be further used to train proprietary AI-machine learning models. The system may utilize iterative backward propagation, forward propagation, error calculation, gradient calculation, and weight update of the large data training set to provide and train the proprietary AI-machine learning models. Indeed, such proprietary AI-machine learning models may predict and anticipate consumer demand, restaurant availability, and event service providers’ availability. In such a manner, the system will allow for a facile user experience for consumers by ensuring accurate restaurant availability. This will also allow the restaurant to predict and anticipate consumer demand, which will aid in food and inventory management. This will also allow the catering companies to predict consumer demand and restaurant availability, which will aid in staff management for the catering companies.

In still a further embodiment, the proprietary AI-machine learning models may be used to train chatbots to converse with each of the various elements, entities, or players (whether restaurant, consumer, catering company, or other service provider) to provide for a facile user experience.

In a further embodiment, the system may allow for communication between the restaurants, catering companies, and consumers via the use of in-house GPS capabilities. Alternatively, the system may be integrated with a mobile device’s map applications to provide accurate positioning and GPS.

In still a further embodiment, the system may comprise an authentication verification mechanism between the restaurants, catering companies, and consumers to ensure safety and accuracy. The authentication verification mechanism may utilize a biometric authentication verification mechanism that uses biometric authentication such as fingerprints and/or face ID. The authentication verification mechanism may further utilize a multifactor authentication system such as biometric authentication in conjunction with device verification.

In a further embodiment, the system may seamlessly calculate the order between the restaurant, consumer, and catering company to ensure quick, facile, and effective distribution of funds between the restaurant and the catering companies. The system may internally perform all bill calculations. Additionally, the system may allow each of the entities (whether restaurant, consumer, catering company, or other service provider) to leave feedback and tips to each of the other entities, as requested or needed. Furthermore, the system may rank the services and qualities of each of the entities to allow for a pleasant user experience.

In a further embodiment, the system may allow each of the entities (whether restaurant, consumer, catering company, or other service provider) to aggregate points. Moreover, such points may be used as credit for future purchases. Indeed, such aggregated points may form a currency within the system such that an entity (whether restaurant, consumer, catering company, or other service provider) may use such points within the system. In still a further embodiment, such aggregated points may form a basis for a stable coin or a cryptocurrency coin within the system. Any entity (whether restaurant, consumer, catering company, or other service provider) may use such a stable coin or cryptocurrency coin within the system accordingly. Moreover, the stable coin’s or the cryptocurrency coin’s use of the aforementioned points as a basis allows for the stability of said stable coin or cryptocurrency coin.

In still another embodiment, the present disclosure may comprise a mobile application that connects and orchestrates between various elements, entities, or players. Further, the mobile application may comprise three separate portals. One portal may be designated for restaurants, wherein restaurants may upload pertinent restaurant data such as address, physical location, availability, and/or detailed menus with pertinent information and costs, among other pertinent data. A second portal may be designated for event service provider companies such as catering companies, florists, and/or event transportation service providers. In this portal, an event service provider company may provide pertinent data such as the type of service provided, associated costs, and/or availability, among other pertinent data. A third portal may be designated for a consumer. In the third portal, the consumer may upload pertinent personal data and/or biometric data for authentication purposes, among other personal data. In this third portal, the consumer may search pertinent restaurant restaurants in the first portal for food and menus that meet his or her needs and budget requirements. Further, the consumer may connect the order from a selected restaurant in the first portal with a catering company selected from the second portal to allow for the catering of the selected restaurant’s food at the consumer’s private or personal event. In this way, the mobile application allows consumers to connect with local catering companies so that consumers can receive food from their favorite restaurants to their homes and/or events when such restaurants do not offer moder in-home catering services. Alternatively or additionally, the catering company or any other event service provider in the second portal may see the incoming orders of the consumers on the first portal and bid for catering and/or other event services accordingly.

In a further embodiment, the mobile application may allow for communication and orchestration between the various elements, entities, or players via the use of a network or a cloud. Alternatively or additionally, the mobile application may allow for communication and orchestration between the various elements, entities, or players by allowing for communication between each of the various elements, entities, or players.

In still a further embodiment, the mobile application may allow for the gathering of all data from each of the various elements, entities, or players. For example, the mobile application may allow for the gathering of restaurant data such as address, physical location, availability, and/or detailed menus with pertinent information and costs, among other personal data from the restaurant, the gathering of event service provider data such as the type of service provided, associated costs, and/or availability, among other personal data, and the gathering of consumer data such as pertinent personal data and/or biometric data for authentication purposes, among other personal data. Thereafter, the mobile application may utilize such data to build a large data training set that may be further used to train proprietary AI-machine learning models. The mobile application may utilize iterative backward propagation, forward propagation, error calculation, gradient calculation, and weight update of the large data training set to provide and train the proprietary AI-machine learning models. Indeed, such proprietary AI-machine learning models may predict and anticipate consumer demand, restaurant availability, and event service providers’ availability. In such a manner, the mobile application will allow for a facile user experience for consumers by ensuring accurate restaurant availability. This will also allow the restaurant to predict and anticipate consumer demand, which will aid in food and inventory management. This will also allow the catering companies to predict consumer demand and restaurant availability, which will aid in staff management for the catering companies.

In still a further embodiment, the proprietary AI-machine learning models may be used to train chatbots to converse with each of the various elements, entities, or players (whether restaurant, consumer, catering company, or other service provider) to provide for a facile user experience in the mobile application.

In a further embodiment, the mobile application may allow for communication between the restaurants, catering companies, and consumers via the use of in-house GPS capabilities. Alternatively, the mobile application may be integrated with a mobile device’s other map applications to provide accurate positioning and GPS.

In still a further embodiment, the mobile application may comprise an authentication verification mechanism between the restaurants, catering companies, and consumers to ensure safety and accuracy. The authentication verification mechanism may utilize a biometric authentication verification mechanism that uses biometric authentication such as fingerprints and/or face ID. The authentication verification mechanism may further utilize a multifactor authentication system such as biometric authentication in conjunction with a device verification.

In a further embodiment, the mobile application may seamlessly calculate the order between the restaurant, consumer, and catering company to ensure quick, facile, and effective distribution of funds between the restaurant and the catering companies. The mobile application may internally perform all bill calculations. Additionally, the mobile application may allow each of the entities (whether restaurant, consumer, catering company, or other service provider) to leave feedback and tips to each of the other entities, as requested or needed. Furthermore, the mobile application may rank the services and qualities of each of the entities to allow for a pleasant user experience.

In a further embodiment, the mobile application may allow each of the entities (whether restaurant, consumer, catering company, or other service provider) to aggregate points. Moreover, such points may be used as credit for future purchases. Indeed, such aggregated points may form a currency within the mobile application such that an entity (whether restaurant, consumer, catering company, or other service provider) may use such points within the mobile application. In still a further embodiment, such aggregated points may form a basis for a stable coin or cryptocurrency coin within the mobile application. Any entity (whether restaurant, consumer, catering company, or other service provider) may use such a stable coin or cryptocurrency coin within the mobile application accordingly. Moreover, the stable coin’s or the cryptocurrency coin’s use of the aforementioned points as a basis allows for the stability of said stable coin or cryptocurrency coin.

In a further embodiment, the present disclosure may comprise a method that connects and orchestrates between various elements, entities, or players. The method may connect and orchestrate between consumers, restaurants, catering companies, and other service providers or service entities seamlessly to allow consumers to order and cater pertinent orders in an efficient, cost-effective, and facile manner. The method may allow consumers to place orders for food from a restaurant selected from a plethora of available restaurants. Alternatively or additionally, the method may allow consumers to mix and match food from various menus emanating from a plurality of restaurants. The consumers may further request service of the restaurant food at a specified date and may choose a pertinent catering company to provide the catering services at said date. The requested order and specified data may then be sent to the penitent restaurant. The restaurant may then accept or decline the sale based on availability. Once the restaurant has accepted the offer, the catering companies have a chance to book the order for pickup and service. Alternatively or additionally, the consumer may selected the appropriate catering company. Thereafter, the catering company may provide a full catering service on the consumer’s specified date, including a full catering event with food being catered in buffets in event spaces or in personal homes. Alternatively or additionally, the consumer may hire further service providers such as florists for floral arrangement of the event space, delivery drivers for the delivery of the food to the event or home, transportation services such as limousines and/or party busses for transporting guests, and/or entertainment services for the events, amongst other services. In this way, the method allows consumers to connect with local catering companies so that consumers can receive food from their favorite restaurants to their homes and/or events when such restaurants do not offer moder in-home catering services. Alternatively or additionally, the catering company or any other event service provider in the second portal may see the incoming orders of the consumers on the first portal and bid for catering and/or other event services accordingly.

In a further embodiment, after requesting service of the restaurant food at a specified date, the consumer may further request services such as an in-house chef, personal chefs, and/or celebrity chefs to be present at the event during the specific date to provide appropriate services. In still a further embodiment, the consumer may request personal chefs that work with commissary kitchens, such that the personal chef may cater for the event. Further, the consumer may request in-house cooking demos from said personal chef or celebrity chef.

In a further embodiment, the method may allow for communication and orchestration between the various elements, entities, or players via the use of a network or a cloud. Alternatively or additionally, the method may allow for communication and orchestration between the various elements, entities, or players by allowing for communication between each of the various elements, entities, or players.

In still a further embodiment, the method may allow for the gathering of all data from each of the various elements, entities, or players. For example, the method may allow for the gathering of restaurant data such as address, physical location, availability, and/or detailed menus with pertinent information and costs, among other personal data from the restaurant, the gathering of event service provider data such as the type of service provided, associated costs, and/or availability, among other personal data, and the gathering of consumer data such as pertinent personal data and/or biometric data for authentication purposes, among other personal data. Thereafter, the method may utilize such data to build a large data training set that may be further used to train proprietary AI-machine learning models. The method may utilize iterative backward propagation, forward propagation, error calculation, gradient calculation, and weight update of the large data training set to provide and train the proprietary AI-machine learning models. Indeed, such proprietary AI-machine learning models may predict and anticipate consumer demand, restaurant availability, and event service providers’ availability. In such a manner, the method will allow for a facile user experience for consumers by ensuring accurate restaurant availability. This will also allow the restaurant to predict and anticipate consumer demand, which will aid in food and inventory management. This will also allow the catering companies to predict consumer demand and restaurant availability, which will aid in staff management for the catering companies.

In still a further embodiment, the proprietary AI-machine learning models may be used to train chatbots to converse with each of the various elements, entities, or players (whether restaurant, consumer, catering company, or other service provider) to provide for a facile user experience.

In a further embodiment, the method may allow for communication between the restaurants, catering companies, and consumers via the use of in-house GPS capabilities. Alternatively, the method may be integrated with a mobile device’s other map applications to provide accurate positioning and GPS.

In still a further embodiment, the method may comprise an authentication verification mechanism between the restaurants, catering companies, and consumers to ensure safety and accuracy. The authentication verification mechanism may utilize a biometric authentication verification mechanism that uses biometric authentication such as fingerprints and/or face ID. The authentication verification mechanism may further utilize a multifactor authentication system such as biometric authentication in conjunction with a device verification.

In a further embodiment, the method may seamlessly calculate the order between the restaurant, consumer, and catering company to ensure quick, facile, and effective distribution of funds between the restaurant and the catering companies. The method may internally perform all bill calculations. Additionally, the method may allow each of the entities (whether restaurant, consumer, catering company, or other service provider) to leave feedback and tips to each of the other entities, as requested or needed. Furthermore, the method may rank the services and qualities of each of the entities to allow for a pleasant user experience.

In a further embodiment, the method may allow each of the entities (whether restaurant, consumer, catering company, or other service provider) to aggregate points. Moreover, such points may be used as credit for future purchases. Indeed, such aggregated points may form a currency within the mobile application such that an entity (whether restaurant, consumer, catering company, or other service provider) may use such points within the mobile application. In still a further embodiment, such aggregated points may form a basis for a stable coin or cryptocurrency coin within the mobile application. Any entity (whether restaurant, consumer, catering company, or other service provider) may use such a stable coin or cryptocurrency coin within the mobile application accordingly. Moreover, the stable coin’s or the cryptocurrency coin’s use of the aforementioned points as a basis allows for the stability of said stable coin or cryptocurrency coin.

In a further embodiment, the present disclosure discloses a computer-implemented system for orchestrating event-related interactions between a plurality of portals, the system comprising a consumer portal executed by at least one processor, wherein the consumer portal comprises a plurality of consumers and is configured to receive consumer order data comprising a service request, an event time, or a budget constraint; a service provider portal executed by at least one processor, wherein the service provider portal comprises a plurality of service providers and is configured to receive service-provider availability data or service-parameter information; a merchant portal executed by at least one processor, wherein the merchant portal comprises a plurality of merchants and is configured to receive merchant availability data, merchant inventory data, menu data, or menu pricing information; an authentication module configured to perform multi-factor authentication comprising biometric verification and device verification to validate access to each of the consumer portal, the service-provider portal, and the merchant portal; and an orchestration engine stored in memory and executed by a processor, wherein the orchestration engine may be configured to receive authenticated consumer order data from the consumer portal; obtain merchant availability data from the merchant portal; generate an event-orchestration record linking the consumer order data with the merchant availability data; determine, based on a timestamp synchronization and inventory verification, whether at least one merchant can fulfill a consumer order; record the determination in an event-orchestration record; transmit the event orchestration record to at least one service provider; and update the event-orchestration record based on a bid or an acceptance received from the at least one service provider.

In still further embodiments, the computer-implemented system for orchestrating event-related interactions may comprise wherein the authentication module performs biometric authentication using facial-recognition data captured from a user device, wherein the user device is associated with at least one consumer, at least one service provider, or at least one merchant.; wherein the multi-factor authentication comprises utilizing a cryptographic device token; wherein the orchestration engine encrypts communication between the consumer portal, the service provider portal, and the merchant portal using symmetric-key cryptography; wherein the orchestration engine ranks the bid using a service quality metric stored in a service-provider performance profile; wherein the orchestration engine determines merchant availability by performing a real-time comparison between the merchant inventory data and the consumer order data; wherein the service-provider portal is configured to display an orchestration queue comprising pending orders awaiting service provider acceptance; wherein the orchestration engine routes the event orchestration record using a message-queue protocol to reduce network latency; wherein the event orchestration record comprises a unique orchestration identifier used to track order state transitions across each of the consumer portal, the service provider portal, and the merchant portal; wherein the orchestration engine is further configured to generate a fallback orchestration record when the merchant declines the consumer order; and wherein the orchestration engine performs error detection on the event orchestration record using a checksum algorithm before transmitting the record.

### BRIEF DESCRIPTION OF DRAWING(S)

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the present disclosure.

FIG. 1 illustrates a block diagram of an exemplary system that connects and orchestrates between various elements, entities, or players, wherein the system comprises three portals.

FIG. 2 illustrates a block diagram an alternative exemplary system that connects and orchestrates between various elements, entities, or players, wherein the system comprises three portals.

FIG. 3 illustrates a block diagram of an exemplary system for the gathering and aggregation of the consumers’ data, service providers’ data, and restaurants’ data into training data.

FIG. 4 illustrates a block diagram of an exemplary system that utilizes consumers’ data to train a machine learning model.

FIG. 5 illustrates a block diagram of an exemplary system that utilizes service providers’ data to train a machine learning model.

FIG. 6 illustrates a block diagram of an exemplary system that utilizes restaurants’ data to train a machine learning model.

FIG. 7 illustrates a block diagram of an exemplary system that aggregates all machine learning models into one machine learning model.

FIG. 8 illustrates a block diagram of an exemplary system that utilizes training data to train a machine learning model.

FIG. 9 illustrates a block diagram of an exemplary system that utilizes machine learning models to train chatbots for each of the various elements, entities, or players.

FIG. 10 illustrates a block diagram of an exemplary system that utilizes a machine learning model to train a chatbot.

FIG. 11 illustrates a block diagram of an alternate exemplary system that utilizes a machine learning model to train a chatbot.

FIG. 12 illustrates a block diagram of an exemplary system that uses aggregated points as a basis for either a stable coin or a cryptocurrency coin.

FIG. 13 illustrates an exemplary method that connects and orchestrates between various elements, entities, or players.

FIGS. 14-22 illustrate an exemplary mobile application that connects and orchestrates between various elements, entities, or players, wherein the mobile application comprises three portals.

### DETAILED DESCRIPTION

Reference will now be made in detail to embodiments of the present disclosure, shown in the accompanying drawings.

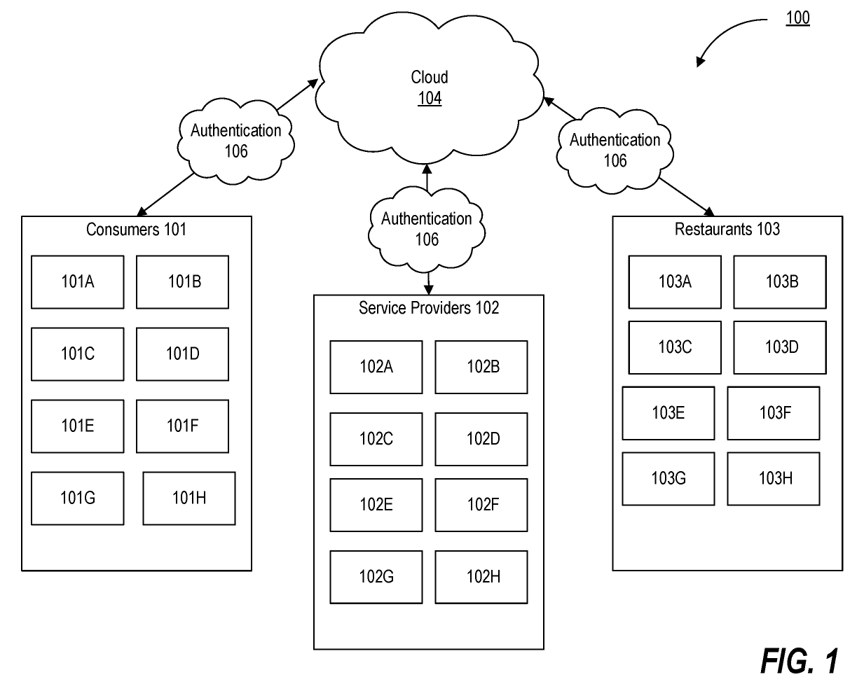

FIG. 1 illustrates a block diagram of an exemplary system 100 that connects and orchestrates between various elements, entities, or players, wherein the system comprises three portals. As seen in FIG. 1, the system 100 may comprise three separate portals: consumers 101, service providers 102, and restaurants 103.

The consumers 101 portal may further comprise of a plurality of consumers 101A-101H. The consumers 101 portal may comprise of more consumers beyond consumer 101H, as need be. Each consumer 101A-101H may comprise pertinent personal data, biometric data for authentication purposes, among other personal data, and/or order data such as service request, event time, and/or budget constraints. The service providers 102 portal may further comprise of a plurality of service providers 102A-102H. The service providers 102A-102H may comprise of more service providers beyond service provider 102H, as need be. The service providers 102A-102H may be catering services, floral services, transportation services, entertainment services, or any other services for events. Each service provider 102A-102H may comprise service provider data such as the type of service provided, associated costs, and/or availability, among other data. The restaurants 103 portal may further comprise a plurality of restaurants 103A-103H. The restaurants 103 portal may comprise more restaurants beyond restaurants 103H, as need be. Each restaurant 103A-103H may comprise restaurant data such as address, physical location, availability, and/or detailed menus with pertinent information and costs, among other data from the restaurant.

As seen in FIG. 1, the cloud 104 or network 104 may be a network of servers that store and manage data, run applications, and deliver services over a network or the internet. The cloud 104 or network 104 allows for flexibility as it may be accessed instantaneously and immediately. Further, the cloud 104 or network 104 allows for cost savings, speed and ease of access. As seen in FIG. 1, each of the consumers 101 portal, service providers 102 portal, and restaurants 103 portal communicates and sends its associated data to a cloud 104 or a network 104. As further seen in FIG. 1, this communication of each of the consumers 101 portal, service providers 102 portal, and restaurants 103 portal with the cloud 104 may be done via an authentication 106. The authentication 106 may be a biometric authentication verification mechanism that uses biometric authentication such as fingerprints and/or face ID. Additionally or alternatively, the authentication 106 may be a multifactor authentication system such as biometric authentication in conjunction with device verification.

Further still, the cloud 104 may comprise an orchestration engine 104 that orchestrates data flows between the consumers 101, the service providers 102, and the restaurants 103. Further still, the cloud 104 may comprise an orchestration engine 104 that orchestrates data between a portal represented by the consumers 101, a portal represented by the service providers 102, and a portal represented by the restaurants 103. Further, the orchestration engine 104 may be stored in memory and/or executed by a processor. Further still, the orchestration engine 104 may receive authenticated consumer data from the consumers 101, receive or obtain service availability data or merchant availability data from the service providers 102, and thereafter generate an event-orchestration record linking the consumer order data from the consumers 101 with the merchant availability data from the restaurant 103. Thereafter, the orchestration engine 104 may determine, based on a timestamp synchronization and/or an inventory verification of the inventory associated with the restaurant 103, whether the merchant or restaurant 103 can fulfill the consumer order associated with the consumer 101. Thereafter, the orchestration engine 104 may record the determination in an event-orchestration record. After which, the orchestration engine 104 may transmit the event-orchestration record to the service provider 102 and update the event-orchestration record based on a bid or an acceptance received from the at least one service provider 102.

Further, the orchestration engine 104 may route the event orchestration record using a message-queue protocol to reduce network latency. Also, the orchestration engine 104 may generate a fallback orchestration record when the merchant declines the consumer order. Further still, the orchestration engine 104 may perform error detection on the event orchestration record using a checksum algorithm before transmitting the record.

Further still, the exemplary system 100 may further comprise a synchronization module, wherein the synchronization module may be configured to align timestamps received from each of the consumer portal, the service provider portal, and the merchant portal using a network time protocol.

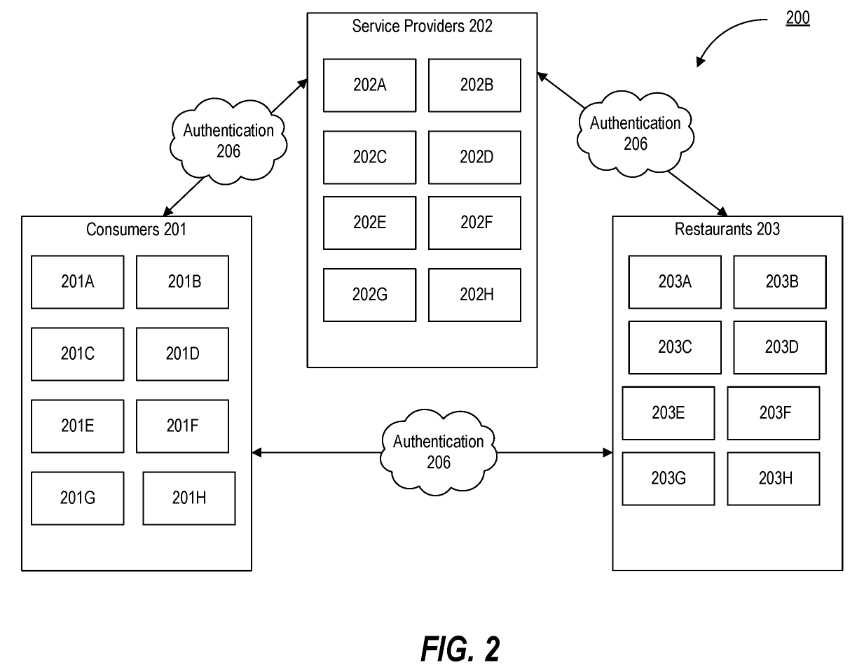

FIG. 2 illustrates a block diagram of an exemplary system 200 that connects and orchestrates between various elements, entities, or players, wherein the system comprises three portals. As seen in FIG. 2, the system 200 may comprise three separate portals: consumers 201, service providers 202, and restaurants 203.

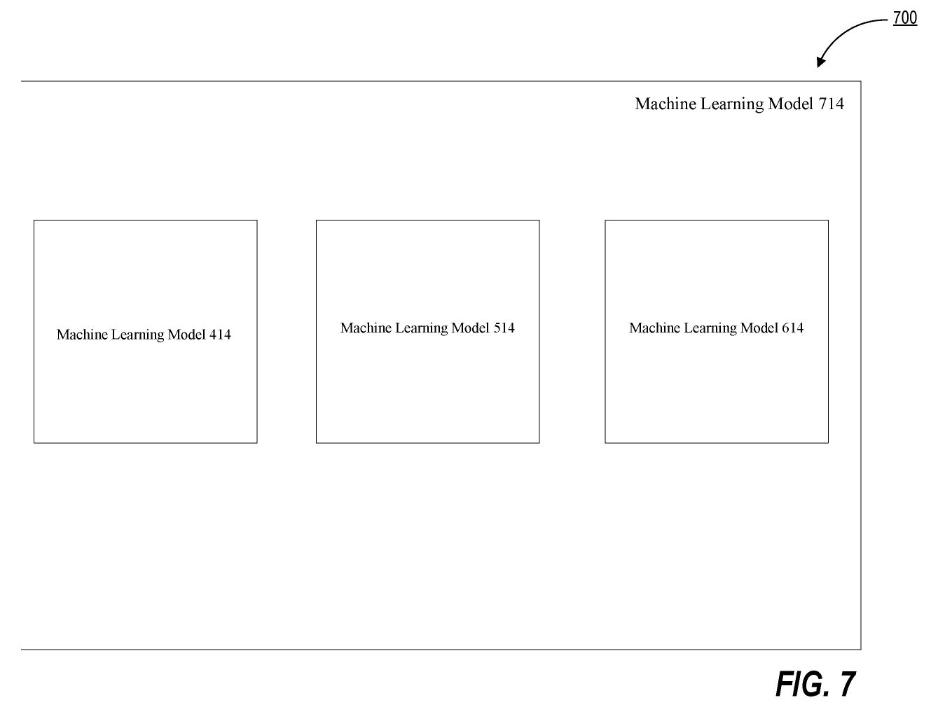

The consumers 201 portal may further comprise of a plurality of consumers 201A-201H. The consumers 201 portal may comprise of more consumers beyond consumer 201H, as need be. Each consumer 201A-201H may comprise pertinent personal data and/or biometric data for authentication purposes, among other personal data. The service providers 202 portal may further comprise of a plurality of service providers 202A-202H. The service providers 202A-202H may comprise of more service providers beyond service provider 202H, as need be. The service providers 202A-202H may be catering services, floral services, transportation services, entertainment services, or any other services for events. Each service provider 202A-202H may comprise service provider data such as the type of service provided, associated costs, and/or availability, among other data. The restaurants 203 portal may further comprise a plurality of restaurants 203A-203H. The restaurants 203 portal may comprise more restaurants beyond restaurants 203H, as need be. Each restaurant 203A-203H may comprise restaurant data such as address, physical location, availability, and/or detailed menus with pertinent information and costs, among other data from the restaurant. FIG. 7 illustrates a block diagram of an exemplary system 700 that aggregates all machine learning models 414, 514, 614 into one machine learning model 714. As seen in FIG. 7, the machine learning model 714 comprises an aggregation of all the aforementioned machine learning models 414, 514, 614. The aggregated machine learning model 714 may be used to train chatbots to converse with each of the various elements, entities, or players (whether restaurant, consumer, catering company, or other service provider) to provide for a facile user experience.

As seen in FIG. 2, each of the consumers 201 portal, service providers 202 portal, and restaurants 203 portal communicates and sends its associated data to each other portal via an authentication 206. The authentication 206 may be a biometric authentication verification mechanism that uses biometric authentication such as fingerprints and/or face ID. Additionally or alternatively, the authentication 206 may be a multifactor authentication system such as biometric authentication in conjunction with device verification.

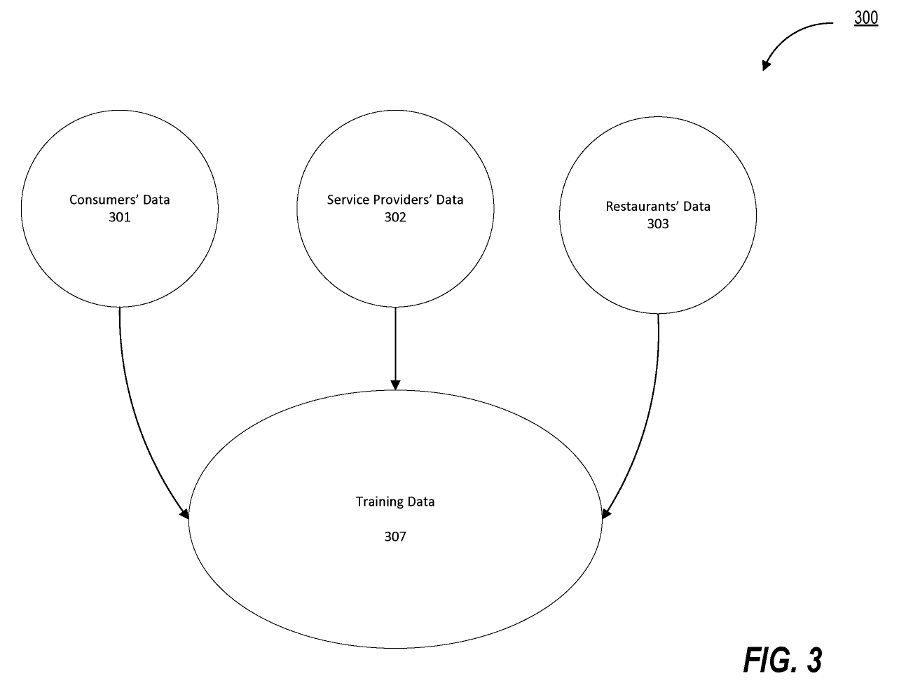

FIG. 3 illustrates a block diagram of an exemplary system 300 for the gathering and aggregation of the consumers’ data 301, service providers’ data 302, and restaurants’ data 303 into training data 307.

As further seen in FIG. 3, the system 300 may allow for the gathering of restaurant data 303 such as address, physical location, availability, and/or detailed menus with pertinent information and costs, among other data from the restaurant, the gathering of event service provider data 302 such as the type of service provided, associated costs, and/or availability, among other data, and the gathering of consumer data 301 such as pertinent personal data and/or biometric data for authentication purposes, among other personal data. As further seen in FIG. 3, all this data, including the consumers’ data 301, service providers’ data 302, and restaurants’ data 303, may be gathered and aggregated into training data 307. Thereafter, the system 300 may utilize the training data 307 to build a large data training set that may be further used to train proprietary AI-machine learning models. Alternatively or additionally, the system 300 may utilize each of consumers’ data 301, service providers’ data 302, and restaurants’ data 303, independently to build and train separate and independent proprietary AI-machine learning models.

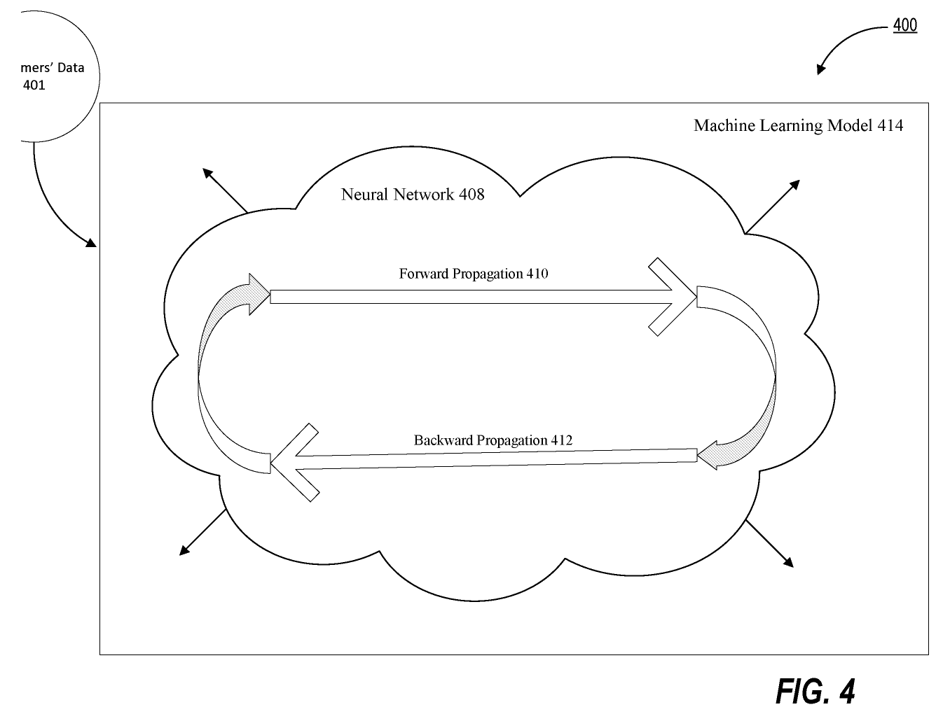

FIG. 4 illustrates a block diagram of an exemplary system 400 that utilizes consumers’ data 401 to train a machine learning model 414.

As seen in FIG. 4, the system 400 utilizes consumers’ data 401 to build and train a proprietary AI-machine learning model 414. As further seen in FIG. 4, the system 400 utilizes forward propagation 410 and backward propagation 412 to build, train, and optimize the machine learning model 414. The forward propagation 410 and backward propagation 412 continuously expand the neural network 408, as seen by the four arrows surrounding the neural network 408. This continuous expansion of the neural network 408 allows for the building, training, and optimizing of the machine learning model 414. Alternatively or additionally, the machine learning model 414 may comprise of a plurality of neural networks 408 to allow for a more accurate and effective machine learning model 414.

During forward propagation 410, the system 400 processes or passes the consumers’ data 401 through the neural network 408 to produce or predict an output or prediction. Specifically, the system 400’s processing or passing of the consumers’ data 401 through the neural network 408 comprises several steps: input layer step, weight application step, activation function step, and output layer step. During the input layer step, the consumers’ data 401 enters the neural network 408 through an input layer. Thereafter, in the weight application step, each neuron of the neural network 408 takes a weighted sum of the inputs of the consumers’ data 401, wherein each connection or edge between neurons of the neural network 408 has a weight that influences the output. Subsequently, in the activation function step, the aforementioned weighted sum passes through an activation function to introduce non-linearity, thereby allowing the neural network 408 to learn more complex patterns. Afterwards, in the output layer step, the process continues from input layer to input layer until it produces an output layer and arrives at a final output or prediction. This final output or prediction is then compared with the actual target values or values to calculate the error or loss. The error or loss indicates how far the machine learning model 414 is from the true value. Finally, as seen in FIG. 4, the final output or prediction of the forward propagation 410 is inputted into the backward propagation 412.

During backward propagation 412, the system 400 updates the neural network 408’s weight to reduce the error based on the final output or prediction. In this manner, the neural network 408 learns by minimizing the aforementioned error or loss calculated during forward propagation 410. Specifically, backward propagation 412 comprises several steps: error calculation step, gradient calculation step, and weight update step. During the error calculation step, a loss function calculates the error or loss between the aforementioned final output or prediction of the forward propagation 410 and an actual target value. Thereafter, in the gradient calculation step, the backward propagation 412 calculates the gradients of the loss function concerning each weight in the neural network 408 via the chain rule, wherein the gradients tell the machine learning model 414 in which direction (and how much) each weight needs to be adjusted to reduce the aforementioned error. Subsequentially, in the weight update step, the backward propagation 412 utilizes a technique called gradient descent to update each weight to minimize the aforementioned error or loss. The size of each weight update is controlled by the system 400’s learning rate, wherein the system 400 continuously updates the weight until the aforementioned error or loss is minimized. Finally, as seen in FIG. 4, the consumers’ data 401 is then cyclically inputted into the forward propagation 410.

As further seen in FIG. 4, the forward propagation 410 and the backward propagation 412 repeat cyclically for many or several training iterations or epochs, as need be, over the consumers’ data 401 until the neural network 408 reaches an acceptable level of accuracy. In this manner, the neural network 408 continues to expand (as noted by the four arrows surrounding the neural network 408), which signifies improved and more accurate predictions with each training iteration. At such a stage, the proprietary AI-machine learning model 414 may accurately predict and anticipate consumer demand. Further, the proprietary AI-machine learning model 414 may also provide other valuable consumer metrics such as consumer behavior, consumer use, consumer buying patterns, amongst many other consumer metrics that may be vitally useful to the other aforementioned portals, such as the service providers 102 and the restaurants 103, among others.

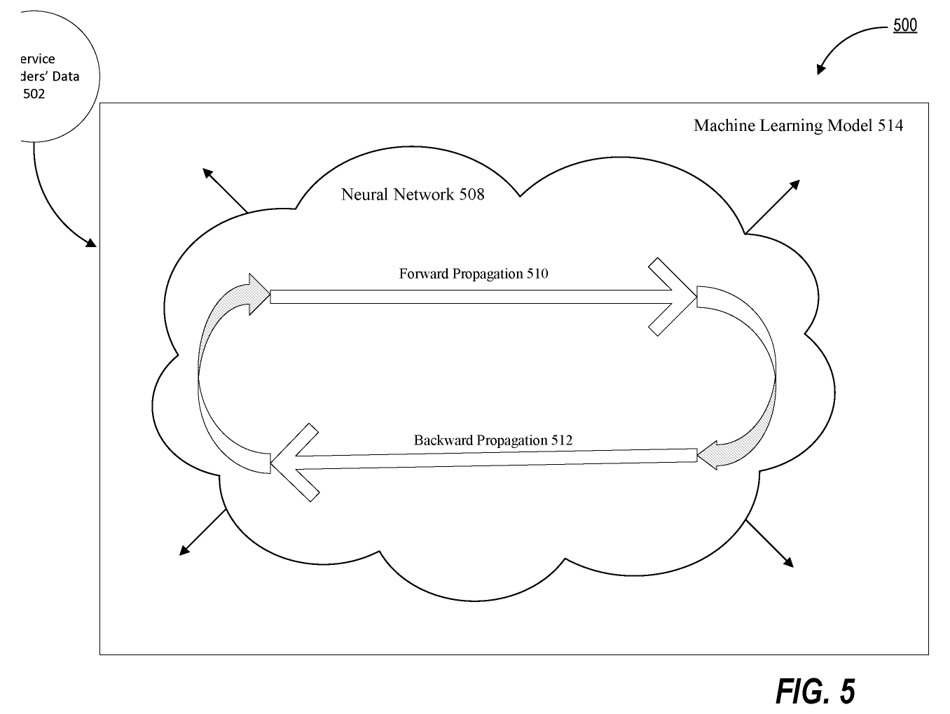

FIG. 5 illustrates a block diagram of an exemplary system 500 that utilizes service providers’ data 502 to train a machine learning model 514.

As seen in FIG. 5, the system 500 utilizes service providers’ data 502 to build and train a proprietary AI-machine learning model 514. As further seen in FIG. 5, the system 500 utilizes forward propagation 510 and backward propagation 512 to build, train, and optimize the machine learning model 514. The forward propagation 510 and backward propagation 512 continuously expand the neural network 508, as seen by the four arrows surrounding the neural network 508. This continuous expansion of the neural network 508 allows for the building, training, and optimizing of the machine learning model 514. Alternatively or additionally, the machine learning model 514 may comprise of a plurality of neural networks 508 to allow for a more accurate and effective machine learning model 514.

During forward propagation 510, the system 500 processes or passes the service providers’ data 502 through the neural network 508 to produce or predict an output or prediction. Specifically, the system 500’s processing or passing of the service providers’ data 502 through the neural network 508 comprises several steps: input layer step, weight application step, activation function step, and output layer step. During the input layer step, the service providers’ data 502 enters the neural network 508 through an input layer. Thereafter, in the weight application step, each neuron of the neural network 508 takes a weighted sum of the inputs of the service providers’ data 502, wherein each connection or edge between neurons of the neural network 508 has a weight that influences the output. Subsequently, in the activation function step, the aforementioned weighted sum passes through an activation function to introduce non-linearity, thereby allowing the neural network 508 to learn more complex patterns. Afterwards, in the output layer step, the process continues from input layer to input layer until it produces an output layer and arrives at a final output or prediction. This final output or prediction is then compared with the actual target values or values to calculate the error or loss. The error or loss indicates how far the machine learning model 514 is from the true value. Finally, as seen in FIG. 5, the final output or prediction of the forward propagation 510 is inputted into the backward propagation 512.

During backward propagation 512, the system 500 updates the neural network 508’s weight to reduce the error based on the final output or prediction. In this manner, the neural network 508 learns by minimizing the aforementioned error or loss calculated during forward propagation 510. Specifically, backward propagation 512 comprises several steps: error calculation step, gradient calculation step, and weight update step. During the error calculation step, a loss function calculates the error or loss between the aforementioned final output or prediction of the forward propagation 510 and an actual target value. Thereafter, in the gradient calculation step, the backward propagation 512 calculates the gradients of the loss function concerning each weight in the neural network 508 via the chain rule, wherein the gradients tell the machine learning model 514 in which direction (and how much) each weight needs to be adjusted to reduce the aforementioned error. Subsequentially, in the weight update step, the backward propagation 512 utilizes a technique called gradient descent to update each weight to minimize the aforementioned error or loss. The size of each weight update is controlled by the system 500’s learning rate, wherein the system 500 continuously updates the weight until the aforementioned error or loss is minimized. Finally, as seen in FIG. 5, the service providers’ data 502 is then cyclically inputted into the forward propagation 510.

As further seen in FIG. 5, the forward propagation 510 and the backward propagation 512 repeat cyclically for many or several training iterations or epochs, as need be, over the service providers’ data 502 until the neural network 508 reaches an acceptable level of accuracy. In this manner, the neural network 508 continues to expand (as noted by the four arrows surrounding the neural network 508), which signifies improved and more accurate predictions with each training iteration. At such a stage, the proprietary AI-machine learning model 514 may accurately predict and anticipate service providers’ availability. Further, the proprietary AI-machine learning model 514 may also provide other valuable service providers’ metrics such as service providers’ behavior, service providers’ use, service providers’ commerce patterns, amongst many other service providers’ metrics that may be vitally useful to the other aforementioned portals, such as the consumers 101 and the restaurants 103, among others.

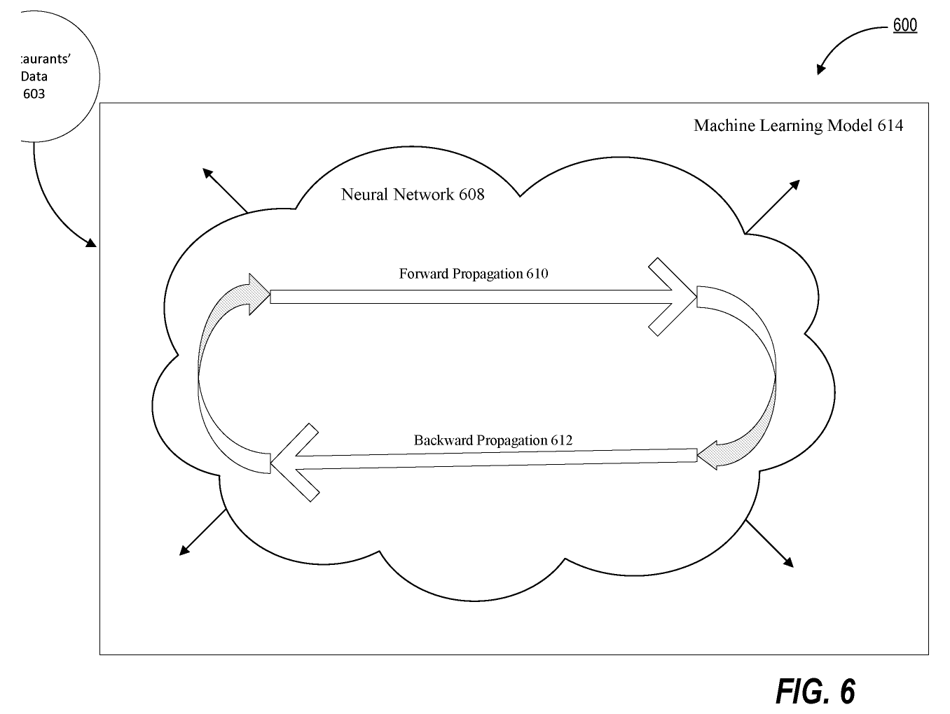

FIG. 6 illustrates a block diagram of an exemplary system 600 that utilizes restaurants’ data 603 to train a machine learning model 614.

As seen in FIG. 6, the system 600 utilizes restaurants’ data 603 to build and train a proprietary AI-machine learning model 614. As further seen in FIG. 6, the system 600 utilizes forward propagation 610 and backward propagation 612 to build, train, and optimize the machine learning model 614. The forward propagation 610 and backward propagation 612 continuously expand the neural network 608, as seen by the four arrows surrounding the neural network 608. This continuous expansion of the neural network 608 allows for the building, training, and optimizing of the machine learning model 614. Alternatively or additionally, the machine learning model 614 may comprise of a plurality of neural networks 608 to allow for a more accurate and effective machine learning model 614.

During forward propagation 610, the system 600 processes or passes the restaurants’ data 603 through the neural network 608 to produce or predict an output or prediction. Specifically, the system 600’s processing or passing of the restaurants’ data 603 through the neural network 608 comprises several steps: input layer step, weight application step, activation function step, and output layer step. During the input layer step, the restaurants’ data 603 enters the neural network 608 through an input layer. Thereafter, in the weight application step, each neuron of the neural network 608 takes a weighted sum of the inputs of the restaurants’ data 603, wherein each connection or edge between neurons of the neural network 608 has a weight that influences the output. Subsequently, in the activation function step, the aforementioned weighted sum passes through an activation function to introduce non-linearity, thereby allowing the neural network 608 to learn more complex patterns. Afterwards, in the output layer step, the process continues from input layer to input layer until it produces an output layer and arrives at a final output or prediction. This final output or prediction is then compared with the actual target values or values to calculate the error or loss. The error or loss indicates how far the machine learning model 614 is from the true value. Finally, as seen in FIG. 6, the final output or prediction of the forward propagation 610 is inputted into the backward propagation 612.

During backward propagation 612, the system 600 updates the neural network 608’s weight to reduce the error based on the final output or prediction. In this manner, the neural network 608 learns by minimizing the aforementioned error or loss calculated during forward propagation 610. Specifically, backward propagation 612 comprises several steps: error calculation step, gradient calculation step, and weight update step. During the error calculation step, a loss function calculates the error or loss between the aforementioned final output or prediction of the forward propagation 610 and an actual target value. Thereafter, in the gradient calculation step, the backward propagation 612 calculates the gradients of the loss function concerning each weight in the neural network 608 via the chain rule, wherein the gradients tell the machine learning model 614 in which direction (and how much) each weight needs to be adjusted to reduce the aforementioned error. Subsequentially, in the weight update step, the backward propagation 612 utilizes a technique called gradient descent to update each weight to minimize the aforementioned error or loss. The size of each weight update is controlled by the system 600’s learning rate, wherein the system 600 continuously updates the weight until the aforementioned error or loss is minimized. Finally, as seen in FIG. 6, the restaurants’ data 603 is then cyclically inputted into the forward propagation 610.

As further seen in FIG. 6, the forward propagation 610 and the backward propagation 612 repeat cyclically for many or several training iterations or epochs, as need be, over the restaurants’ data 603 until the neural network 608 reaches an acceptable level of accuracy. In this manner, the neural network 608 continues to expand (as noted by the four arrows surrounding the neural network 608), which signifies improved and more accurate predictions with each training iteration. At such a stage, the proprietary AI-machine learning model 614 may accurately predict and anticipate restaurant availability. Further, the proprietary AI-machine learning model 614 may also provide other valuable restaurant metrics such as restaurant behavior, restaurant use, restaurant supply patterns, restaurant food and stock availability, amongst many other restaurant metrics that may be vitally useful to the other aforementioned portals, such as the consumers 101 and service providers 102, among others

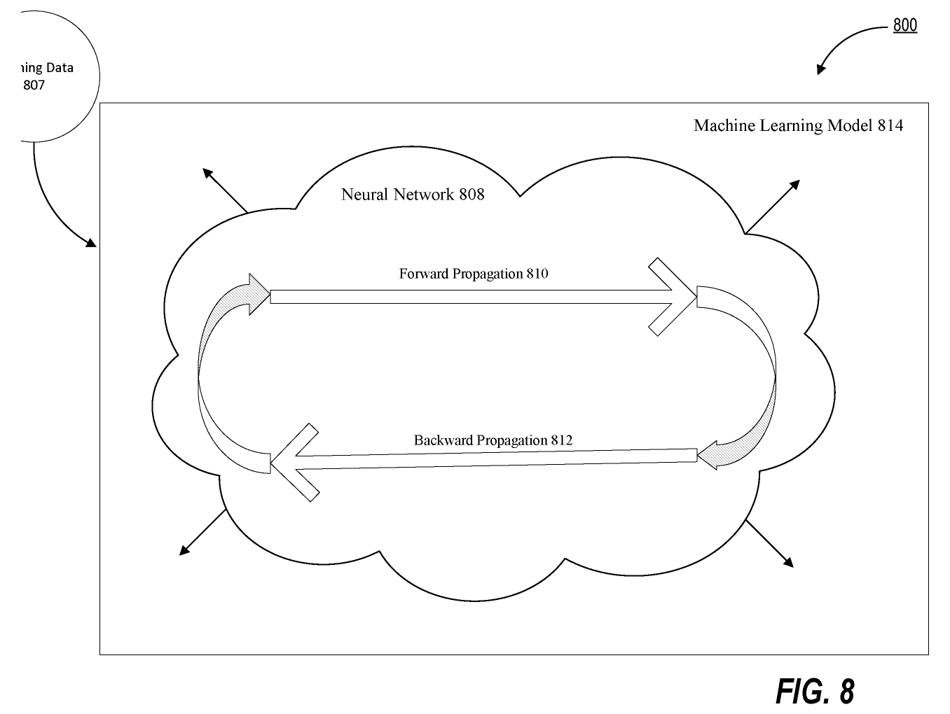

FIG. 8 illustrates a block diagram of an exemplary system 800 that utilizes training data 807 to train a machine learning model 814.

As seen in FIG. 8, the system 800 utilizes training data 807, which itself is an aggregation of consumers’ data 301, service providers’ data 302, and restaurants’ data 303 as seen in FIG. 3, to build and train a proprietary AI-machine learning model 814. As further seen in FIG. 8, the system 800 utilizes forward propagation 810 and backward propagation 812 to build, train, and optimize the machine learning model 814. The forward propagation 810 and backward propagation 812 continuously expand the neural network 808, as seen by the four arrows surrounding the neural network 808. This continuous expansion of the neural network 808 allows for the building, training, and optimizing of the machine learning model 814. Alternatively or additionally, the machine learning model 814 may comprise of a plurality of neural networks 808 to allow for a more accurate and effective machine learning model 814.

During forward propagation 810, the system 800 processes or passes the training data 807 through the neural network 808 to produce or predict an output or prediction. Specifically, the system 800’s processing or passing of the training data 807 through the neural network 808 comprises several steps: input layer step, weight application step, activation function step, and output layer step. During the input layer step, the training data 807 enters the neural network 808 through an input layer. Thereafter, in the weight application step, each neuron of the neural network 808 takes a weighted sum of the inputs of the training data 807, wherein each connection or edge between neurons of the neural network 808 has a weight that influences the output. Subsequently, in the activation function step, the aforementioned weighted sum passes through an activation function to introduce non-linearity, thereby allowing the neural network 808 to learn more complex patterns. Afterwards, in the output layer step, the process continues from input layer to input layer until it produces an output layer and arrives at a final output or prediction. This final output or prediction is then compared with the actual target values or values to calculate the error or loss. The error or loss indicates how far the machine learning model 814 is from the true value. Finally, as seen in FIG. 8, the final output or prediction of the forward propagation 810 is inputted into the backward propagation 812.

During backward propagation 812, the system 800 updates the neural network 808’s weight to reduce the error based on the final output or prediction. In this manner, the neural network 808 learns by minimizing the aforementioned error or loss calculated during forward propagation 810. Specifically, backward propagation 812 comprises several steps: error calculation step, gradient calculation step, and weight update step. During the error calculation step, a loss function calculates the error or loss between the aforementioned final output or prediction of the forward propagation 810 and an actual target value. Thereafter, in the gradient calculation step, the backward propagation 812 calculates the gradients of the loss function concerning each weight in the neural network 808 via the chain rule, wherein the gradients tell the machine learning model 814 in which direction (and how much) each weight needs to be adjusted to reduce the aforementioned error. Subsequentially, in the weight update step, the backward propagation 812 utilizes a technique called gradient descent to update each weight to minimize the aforementioned error or loss. The size of each weight update is controlled by the system 800’s learning rate, wherein the system 800 continuously updates the weight until the aforementioned error or loss is minimized. Finally, as seen in FIG. 8, the training data 807 is then cyclically inputted into the forward propagation 810.

As further seen in FIG. 8, the forward propagation 810 and the backward propagation 812 repeat cyclically for many or several training iterations or epochs, as need be, over the training data 807 until the neural network 808 reaches an acceptable level of accuracy. In this manner, the neural network 808 continues to expand (as noted by the four arrows surrounding the neural network 808), which signifies improved and more accurate predictions with each training iteration. At such a stage, the proprietary AI-machine learning model 814 may accurately predict and anticipate consumer demand, service providers’ availability, and restaurant availability. Further, the proprietary AI-machine learning model 814 may also provide other valuable metrics such as behavior, use, commerce patterns, among many other metrics, for the consumers, service providers, and restaurants, wherein such metrics may be vitally useful to the other aforementioned portals, such as the consumers 101, service providers 102, and the restaurants 103, among others.

In still further embodiments, the present disclosure may disclose a machine-learning system for predicting availability of entities within an event-orchestration network, the system comprising a first data-ingestion module executed by at least one processor and configured to receive consumer-behavior data comprising historical request frequencies, ordering patterns, or temporal usage metrics; a second data-ingestion module executed by the at least one processor and configured to receive service-provider availability data comprising historical acceptance rates, service times, or performance metrics; a third data-ingestion module executed by the at least one processor and configured to receive merchant data comprising inventory levels, menu-item availability, or merchant operational hours; a neural-network model comprising an input layer, one or more hidden layers, and an output layer; and a training engine stored in memory and executed by the at least one processor, the training engine configured to aggregate consumer-behavior data, service-provider data, and merchant data into a combined training dataset; perform a forward-propagation process across the neural-network model using weighted sums and nonlinear activation functions applied to the combined training dataset; compute a loss value based on a predicted availability output and a ground-truth availability label; perform a backward-propagation process using gradient computations based on the loss value; and update the neural-network model’s parameters according to the gradient computations to generate a predictive availability model.

The system may further comprise wherein the backward-propagation process comprises computing gradients using a stochastic gradient descent optimizer or an adaptive learning-rate optimizer; wherein the neural-network model comprises a plurality of parallel neural networks whose outputs are aggregated by an ensemble aggregation module; wherein the ensemble aggregation module combines outputs using weighted averaging or majority voting; wherein the combined training dataset is normalized using feature scaling, min-max normalization, or z-score normalization; wherein the training engine is further configured to generate an availability-prediction score for a merchant, a service provider, or both; wherein the first data-ingestion module receives consumer-behavior data from a consumer portal comprising a plurality of consumers; wherein the second data-ingestion module receives service-provider performance data from a service-provider portal comprising a plurality of service providers; wherein the third data-ingestion module receives inventory-availability data from a merchant portal comprising a plurality of merchants; wherein the training engine performs a batch-training process comprising dividing the combined training dataset into batches and executing forward-propagation and backward-propagation for each batch; wherein the predictive availability model is configured to output separate availability predictions for consumer requests, merchant order fulfillment, and service-provider acceptance.

In still further embodiments, the present disclosure may disclose a computer-implemented method for training a machine-learning availability-prediction model, the method comprising receiving consumer-behavior data from a consumer portal comprising a plurality of consumers; receiving service-provider availability data from a service-provider portal comprising a plurality of service providers; receiving merchant data from a merchant portal comprising a plurality of merchants; generating a combined training dataset from the consumer-behavior data, the service-provider availability data, and the merchant data; performing a forward-propagation process through a neural network to generate a predicted availability value; computing a loss function using the predicted availability value and a ground-truth label; performing a backward-propagation process to compute gradients; and updating neural-network parameters based on the gradients to refine the availability-prediction model.

The method may further comprise normalizing the combined training dataset prior to performing the forward-propagation process. Further, the method may further comprise performing the backward-propagation process comprises applying an adaptive learning-rate algorithm. Further still, the may further comprise generating separate availability predictions for merchant fulfillment and service-provider acceptance.

In further embodiments, the present disclosure may disclose one or more non-transitory computer-readable media storing instructions that, when executed by at least one processor, cause the processor to receive consumer-behavior data, service-provider availability data, and merchant data; generate a combined training dataset; execute a forward-propagation process through a neural network to generate a predicted availability value; compute a loss function; perform backward propagation to compute gradients; update neural-network parameters based on the gradients; and output an availability-prediction score for at least one merchant or service provider. The instructions may further comprise causing the processor to normalize the combined training dataset; causing the processor to aggregate outputs from a plurality of neural-network models to generate an ensemble availability prediction; and/or causing the processor to store the availability-prediction score in a historical event log for future analysis.

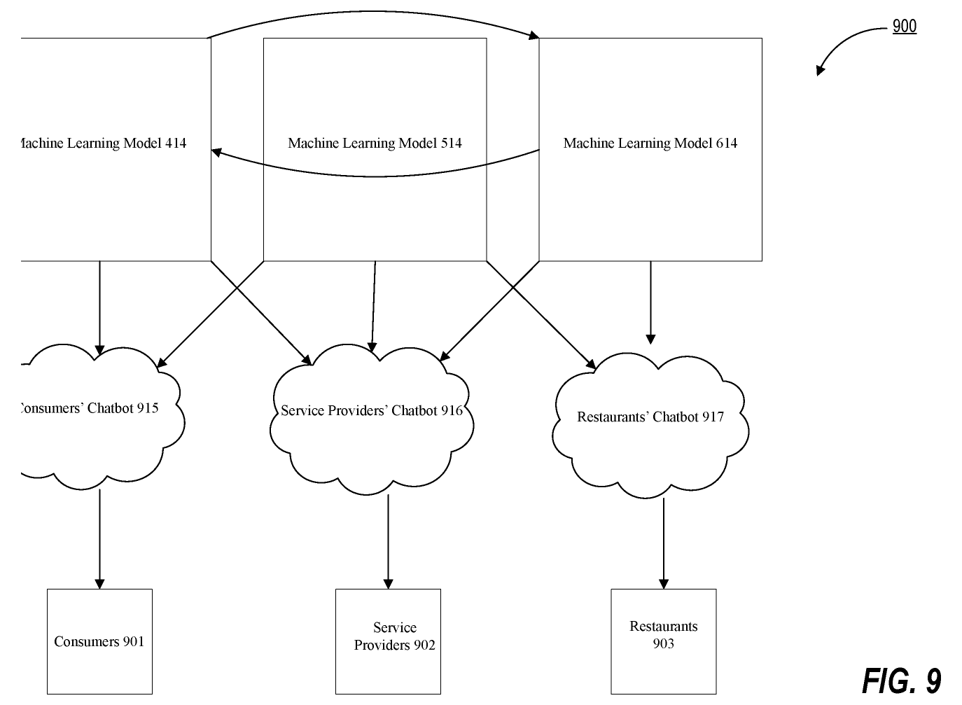

FIG. 9 illustrates a block diagram of an exemplary system 900 that utilizes machine learning models 414, 514, 614 to train chatbots 915, 916, 917 for each of the various elements, entities, or players.

As seen in FIG. 9, the proprietary AI-machine learning models 414, 514, 614 may be used to train a consumers’ chatbot 915 that interacts and converses with the consumers 901 to provide for a facile user experience. The consumers’ chatbot 915 may imbibe all the acquired data and metrics associated with the machine learning model 414 of FIG. 4, the machine learning model 514 of FIG. 5, and the machine learning model 614 of FIG. 6.

As also seen in FIG. 9, the proprietary AI-machine learning models 414, 514, 614 may be used to train a service providers’ chatbot 916 that interacts and converses with the service providers 902 to provide for a facile user experience. The service providers’ chatbot 916 may imbibe all the acquired data and metrics associated with the machine learning model 414 of FIG. 4, the machine learning model 514 of FIG. 5, and the machine learning model 614 of FIG. 6.

As further seen in FIG. 9, the proprietary AI-machine learning models 414, 514, 614 may be used to train a restaurants’ chatbot 916 that interacts and converses with the restaurants 903 to provide for a facile user experience. The restaurants’ chatbot 917 may imbibe all the acquired data and metrics associated with the machine learning model 414 of FIG. 4, the machine learning model 514 of FIG. 5, and the machine learning model 614 of FIG. 6.

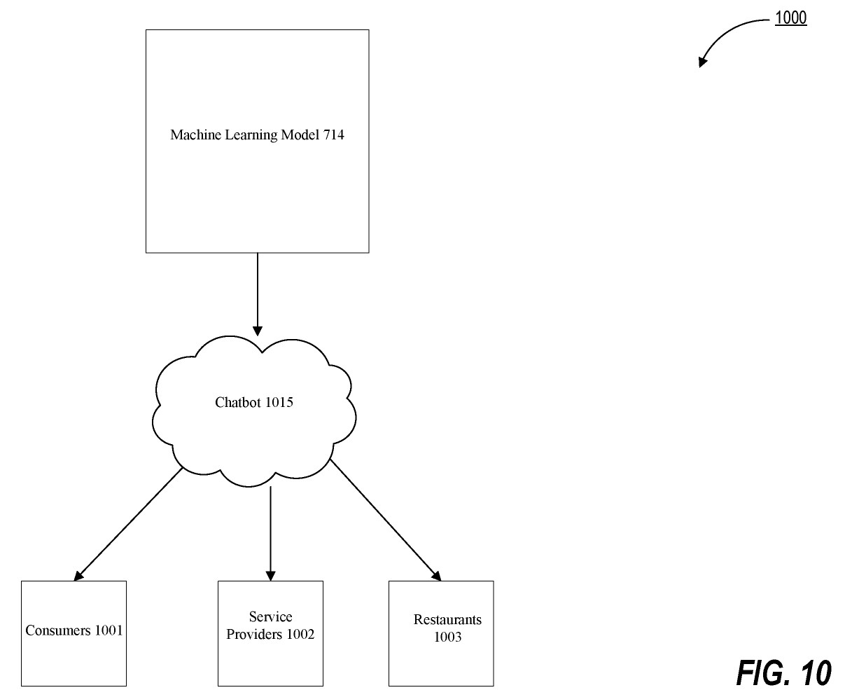

FIG. 10 illustrates a block diagram of an exemplary system 1000 that utilizes a machine learning model 714 to train a chatbot 1015.

As seen in FIG. 10, the proprietary AI-machine learning model 714 may be used to train a general chatbot 1015 that interacts and converses with the consumers 1001, service providers 1002, and restaurants 1003, to provide for a facile user experience. The chatbot 1015 may imbibe all the acquired data and metrics associated with the machine learning model 714 of FIG. 7.

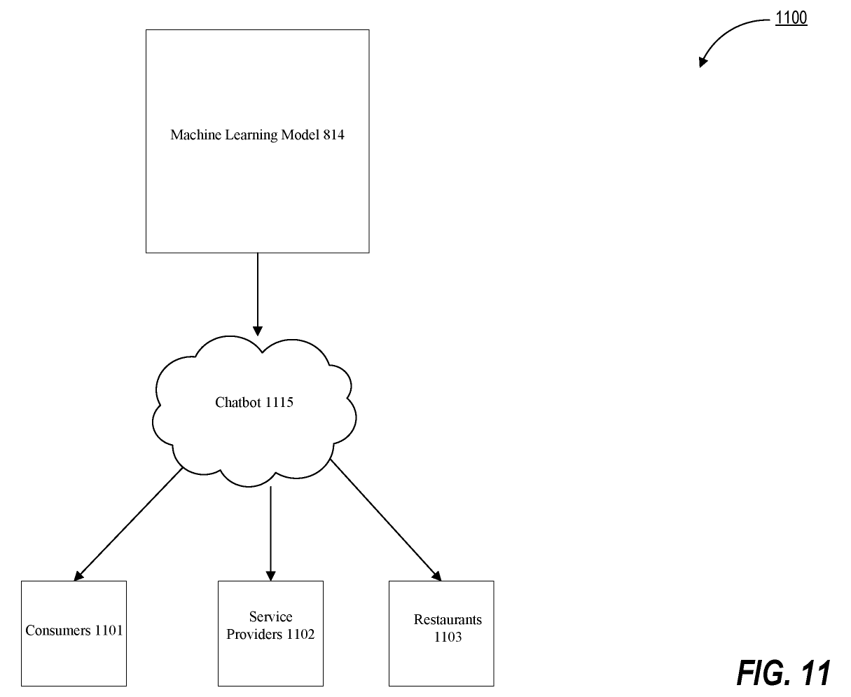

FIG. 11 illustrates a block diagram of an alternate exemplary system 1100 that utilizes a machine learning model 814 to train a chatbot 1115.

As seen in FIG. 11, the proprietary AI-machine learning model 814 may be used to train a general chatbot 1115 that interacts and converses with the consumers 1101, service providers 1102, and restaurants 1103, to provide for a facile user experience. The chatbot 1115 may imbibe all the acquired data and metrics associated with the machine learning model 814 of FIG. 8.

In further embodiments, the present disclosure may comprise a computer-implemented system for generating multi-entity conversational responses in an event-orchestration network, the system comprising a consumer chatbot model trained using consumer-behavior data comprising historical requests, communication patterns, or temporal interaction metrics; a service-provider chatbot model trained using service-provider performance data comprising availability patterns, acceptance rates, or service-duration metrics; a merchant chatbot model trained using merchant data comprising menu availability, inventory levels, or merchant operating attributes; a model-selection module executed by at least one processor and configured to identify an entity type associated with an incoming message; a model-aggregation module executed by the at least one processor and configured to receive outputs from at least two of the chatbot models; and a conversational engine executed by at least one processor, the conversational engine configured to receive an input message from a consumer portal, a service-provider portal, or a merchant portal; select, via the model-selection module, a particular chatbot model based on the entity type; generate a first predicted response using the selected chatbot model; generate a second predicted response using at least one additional chatbot model; aggregate the first predicted response and the second predicted response via the model-aggregation module to form a unified conversational output; and transmit the unified conversational output to the requesting portal.

In still further embodiments, computer-implemented system for generating multi-entity conversational may be such wherein the consumer chatbot model, service-provider chatbot model, and merchant chatbot model are each generated using training data output by a machine-learning availability-prediction model; wherein the model-aggregation module applies weighted averaging to combine predicted responses; wherein the model-aggregation module applies confidence-score weighting based on respective model accuracies; wherein the conversational engine further comprises a contextual-state buffer configured to store prior conversational messages for context-aware response generation; wherein the model-selection module identifies the entity type based on metadata included in the incoming message; wherein the consumer chatbot model is trained using user-interaction sequences collected from the consumer portal comprising a plurality of consumers; wherein the service-provider chatbot model is trained using service-provider interactions collected from a service-provider portal comprising a plurality of service providers; wherein the merchant chatbot model is trained using merchant-portal interactions collected from a merchant portal comprising a plurality of merchants; wherein the conversational engine further generates an interaction-quality metric associated with the unified conversational output; wherein the model-aggregation module applies a neural-network–based fusion model to combine predicted responses; wherein the conversational engine updates at least one of the chatbot models using feedback data received from the requesting portal.

In further embodiments, the present disclosure may comprise a computer-implemented method for generating multi-entity conversational responses, the method comprising receiving an input message from a user associated with a consumer portal, a service-provider portal, or a merchant portal; identifying, via a model-selection module, an entity type associated with the input message; selecting a chatbot model trained for the identified entity type; generating a first predicted response using the selected chatbot model; generating a second predicted response using at least one additional chatbot model; aggregating the first predicted response and the second predicted response to form a unified conversational output; and transmitting the unified conversational output to the user.

The method may further comprise storing at least one prior message in a contextual-state buffer to provide context for generating the unified conversational output; aggregating comprises applying a confidence-based weighting function to the predicted responses, and updating at least one chatbot model using user feedback obtained from the transmitted unified conversational output.

In still further embodiments, the present disclosure may comprise one or more non-transitory computer-readable media storing instructions that, when executed by at least one processor, cause the processor to receive an input message from a consumer portal, a service-provider portal, or a merchant portal; identify an entity type associated with the input message; select a chatbot model trained for the identified entity type; generate a first predicted response using the selected chatbot model; generate a second predicted response using at least one additional chatbot model; aggregate the first predicted response and the second predicted response to form a unified conversational output; and transmit the unified conversational output to the requesting portal.

Further, the instructions may further cause the processor to store conversational context in a contextual-state buffer; cause the processor to apply a confidence-score weighting scheme when aggregating predicted responses; or cause the processor to update at least one chatbot model using feedback associated with the unified conversational output.

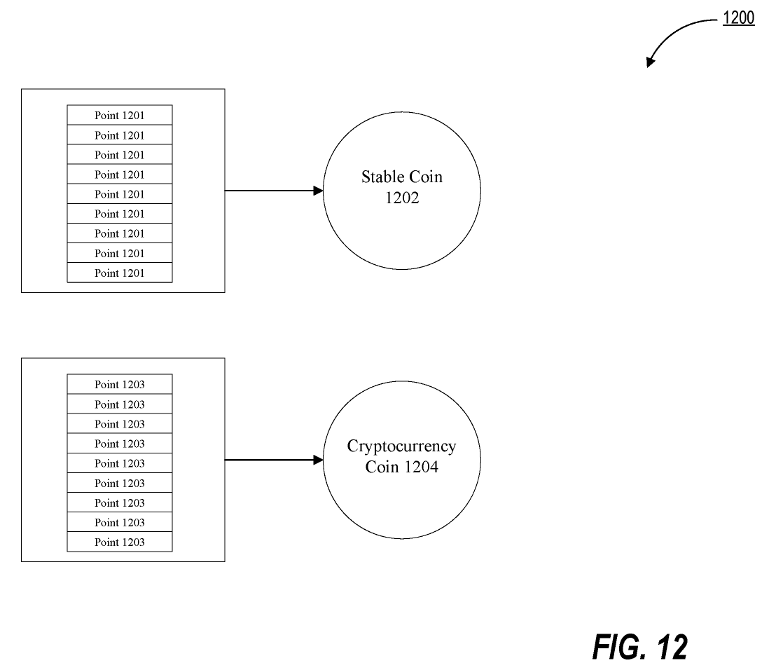

FIG. 12 illustrates a block diagram of an exemplary system 1200 that uses aggregated points 1201, 1203 as a basis for either a stable coin 1202 or a cryptocurrency coin 1204.

As seen in FIG. 12, the system 1201 may allow each of the entities (whether restaurants 103, consumers 101, catering company 102, or other service provider 102) to aggregate points 1201, 1203. Moreover, such points 1201, 1203 may be used as credit for future purchases. As seen in FIG. 12, such aggregated points 1201, 1203 may form a currency within the system 1200 such that an entity (whether restaurant 103, consumer 101, catering company 102, or other service provider 102) may use such points 1201, 1203 within the system 1200.

As further seen in FIG. 12, aggregated points 1201 may form a basis for a stable coin 1202 within the system 1200. Further, aggregated points 1203 may form a basis for a cryptocurrency coin 1204 within the system 1200. Any entity (whether restaurant 103, consumer 101, catering company 102, or other service provider 102) may use such a stable coin 1202 or cryptocurrency coin 1204 within the system 1200 accordingly. Moreover, the stable coin 1202’s or the cryptocurrency coin 1204’s use of the aforementioned points 1201, 1203 as a basis allows for the stability of said stable coin 1202 or cryptocurrency coin 1204.

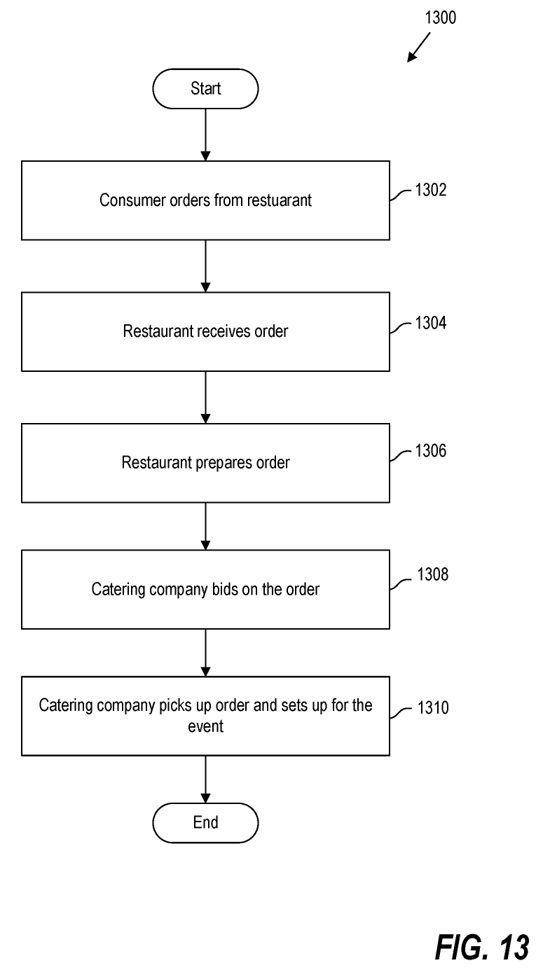

FIG. 13 illustrates an exemplary method 1300 that connects and orchestrates between various elements, entities, or players.

As seen in FIG. 13, in step 1302, a consumer 101 may order from a restaurant 103. In step 1304, the restaurant 103 receives the order. In step 1306, the restaurant 103 prepares the order. In step 1308, the catering company 102 bids on the order. In step 1310, the catering company 102 picks up the order and sets up a catering service for the event.

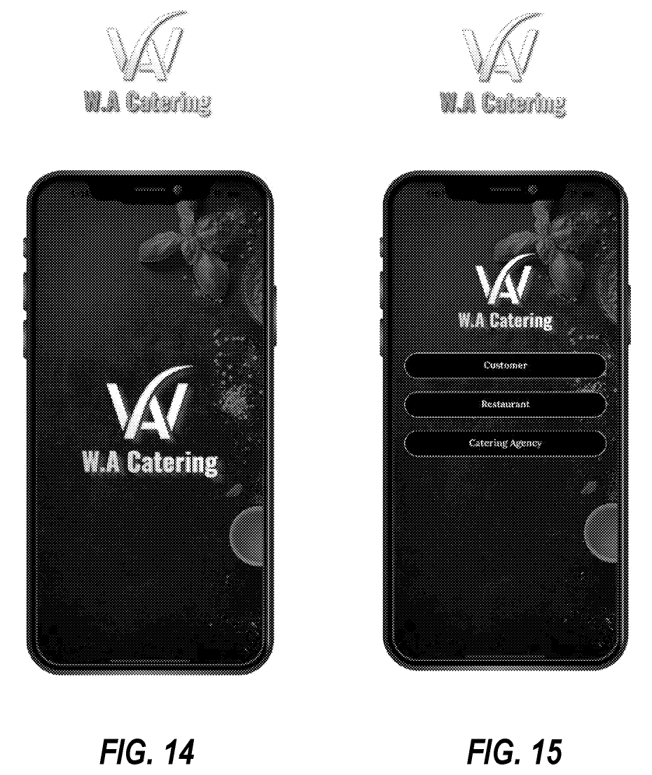

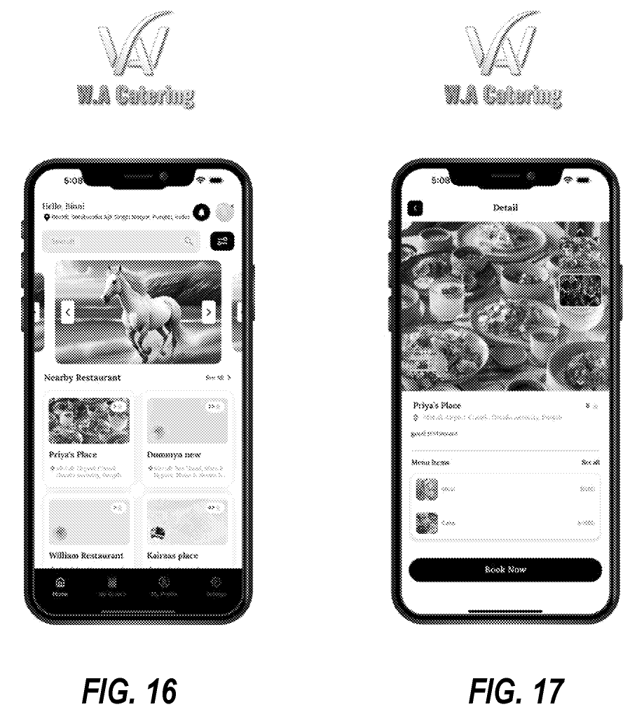

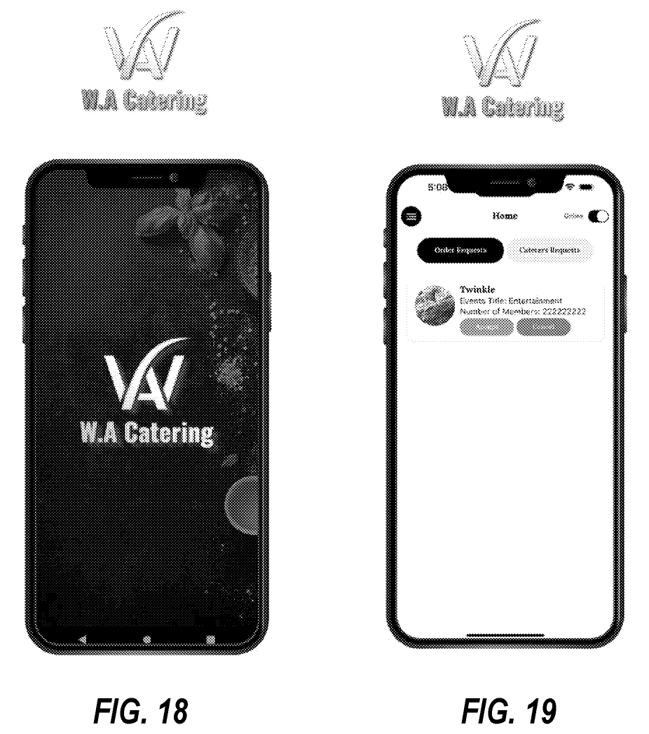

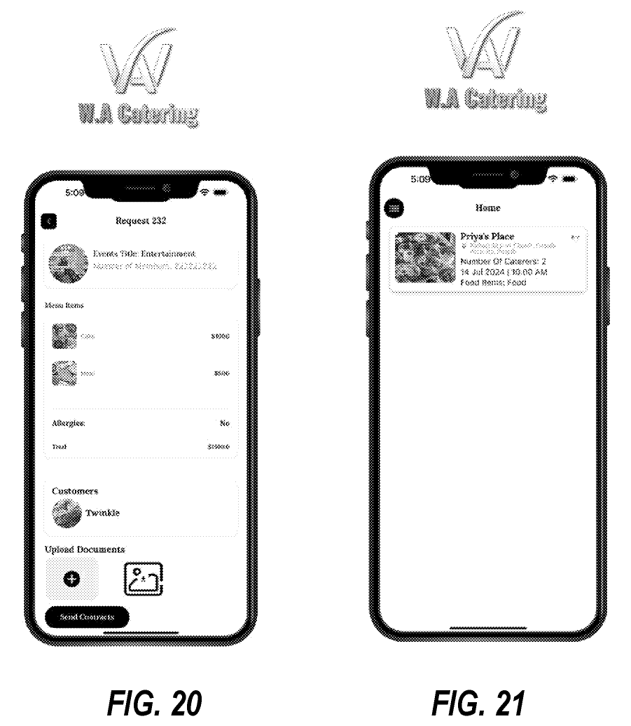

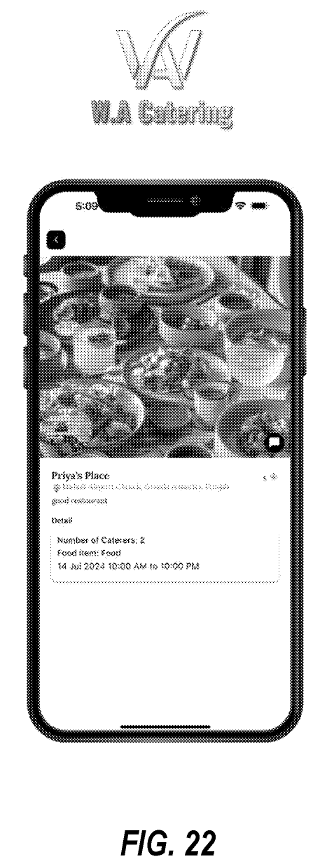

FIGS. 14-22 illustrate an exemplary mobile application that connects and orchestrates between various elements, entities, or players, wherein the mobile application comprises three portals.

As seen in FIGS. 14-22, the mobile application may allow for the gathering of all data from each of the various elements, entities, or players. For example, the mobile application may allow for the gathering of restaurant data such as address, physical location, availability, and/or detailed menus with pertinent information and costs, among other personal data from the restaurant, the gathering of event service provider data such as the type of service provided, associated costs, and/or availability, among other personal data, and the gathering of consumer data such as pertinent personal data and/or biometric data for authentication purposes, among other personal data. Thereafter, the mobile application may utilize such data to build a large data training set that may be further used to train proprietary AI-machine learning models. The mobile application may utilize iterative backward propagation, forward propagation, error calculation, gradient calculation, and weight update of the large data training set to provide and train the proprietary AI-machine learning models. Indeed, such proprietary AI-machine learning models may predict and anticipate consumer demand, restaurant availability, and event service providers’ availability. In such a manner, the mobile application will allow for a facile user experience for consumers by ensuring accurate restaurant availability. This will also allow the restaurant to predict and anticipate consumer demand, which will aid in food and inventory management. This will also allow the catering companies to predict consumer demand and restaurant availability, which will aid in staff management for the catering companies.

It will be apparent to persons skilled in the art that various modifications and variations can be made to the disclosed structure. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A computer-implemented system for orchestrating event-related interactions between a plurality of portals, the system comprising:
a consumer portal executed by at least one processor, wherein the consumer portal comprises a plurality of consumers and is configured to receive consumer order data comprising a service request, an event time, or a budget constraint;
a service provider portal executed by at least one processor, wherein the service provider portal comprises a plurality of service providers and is configured to receive service-provider availability data or service-parameter information;
a merchant portal executed by at least one processor, wherein the merchant portal comprises a plurality of merchants and is configured to receive merchant availability data, merchant inventory data, menu data, or menu pricing information;
an authentication module configured to perform multi-factor authentication comprising biometric verification and device verification to validate access to each of the consumer portal, the service-provider portal, and the merchant portal; and
an orchestration engine stored in memory and executed by a processor, the orchestration engine configured to:
receive authenticated consumer order data from the consumer portal;
obtain merchant availability data from the merchant portal;
generate an event-orchestration record linking the consumer order data with the merchant availability data;
determine, based on a timestamp synchronization and inventory verification, whether at least one merchant can fulfill a consumer order;
record the determination in an event-orchestration record;
transmit the event orchestration record to at least one service provider; and
update the event-orchestration record based on a bid or an acceptance received from the at least one service provider.

2. The system of claim 1, wherein the authentication module performs biometric authentication using facial-recognition data captured from a user device, wherein the user device is associated with at least one consumer, at least one service provider, or at least one merchant.

3. The system of claim 1, wherein the multi-factor authentication comprises utilizing a cryptographic device token.

4. The system of claim 1, wherein the orchestration engine encrypts communication between the consumer portal, the service provider portal, and the merchant portal using symmetric-key cryptography.

5. The system of claim 1, wherein the orchestration engine ranks the bid using a service quality metric stored in a service-provider performance profile.

6. The system of claim 1, wherein the orchestration engine determines merchant availability by performing a real-time comparison between the merchant inventory data and the consumer order data.

7. The system of claim 1, wherein the service-provider portal is configured to display an orchestration queue comprising pending orders awaiting service provider acceptance.

8. The system of claim 1, wherein the orchestration engine routes the event orchestration record using a message-queue protocol to reduce network latency.

9. The system of claim 1, further comprising a synchronization module configured to align timestamps received from each of the consumer portal, the service provider portal, and the merchant portal using a network time protocol.

10. The system of claim 1, wherein the event orchestration record comprises a unique orchestration identifier used to track order state transitions across each of the consumer portal, the service provider portal, and the merchant portal.

11. The system of claim 1, wherein the orchestration engine is further configured to generate a fallback orchestration record when the merchant declines the consumer order.

12. The system of claim 1, wherein the orchestration engine performs error detection on the event orchestration record using a checksum algorithm before transmitting the record.

13. A computer-implemented method for orchestrating interactions between a plurality of entities in an event-management environment, the method comprising:
receiving consumer order data via a consumer portal, wherein the consumer portal comprises a plurality of consumers;
authenticating at least one consumer using biometric verification and device-level verification;
receiving merchant availability data via a merchant portal, wherein the merchant portal comprises a plurality of merchants;
generating an event orchestration record linking the consumer order data with the merchant availability data;
transmitting the event-orchestration record to at least one service provider;
receiving a bid or acceptance from the at least one service provider; and
updating the event orchestration record based on the bid or acceptance.

14. The method of claim 13, further comprising generating a notification to at least one consumer when merchant availability is confirmed.

15. The method of claim 13, wherein receiving the bid or acceptance comprises receiving a digitally signed response from the at least one service provider.

16. The method of claim 13, further comprising detecting a conflict between two service-provider bids and automatically resolving the conflict based on a predefined selection rule.

17. One or more non-transitory computer-readable media storing instructions that, when executed by at least one processor, cause the processor to:
receive consumer order data from a consumer portal, wherein the consumer portal comprises a plurality of consumers;
authenticate the consumer using biometric verification and device-level verification;
obtain merchant availability data from a merchant portal, wherein the merchant portal comprises a plurality of merchants;
generate an event orchestration record linking the consumer order data with the merchant availability data;
transmit the event orchestration record to at least one service provider;
receive a bid or acceptance from the at least one service provider; and
update the event orchestration record based on the bid or acceptance.

18. The one or more non-transitory computer-readable media of claim 17, wherein the instructions further cause the processor to generate a consumer-facing confirmation message comprising a merchant-acceptance status and a service-provider bid status.

19. The one or more non-transitory computer-readable media of claim 17, wherein the orchestration engine validates the event-orchestration record by comparing merchant-response timestamps.

20. The one or more non-transitory computer-readable media of claim 17, wherein the instructions further cause the processor to store the updated event orchestration record in a historical event log.
